(19) United States
(12) Patent Application Publication
(10) Pub. No.: US 2005/0144066 A1
(43) Pub. Date: Jun. 30, 2005

(54) Individually controlled and protected targeted incentive distribution system

(75) Inventors: Daniel P. Cope, Boca Raton, FL (US); Alexander D. Cope, Boca Raton, FL (US)

Correspondence Address: ROBERT C. KAIN, JR., 750 SOUTHEAST THIRD AVENUE, SUITE 100, FT LAUDERDALE, FL, 333161153, US

(73) Assignee: ICOOD, LLC

(21) Appl. No.: 10/742,113

(22) Filed: Dec. 19, 2003

(51) Int. Cl. G06F 17/60

(52) U.S. Cl. 705/14; 705/35

(57) ABSTRACT

A targeted information and incentive distribution system that protects consumer privacy and analyzes individuals', including individual households' or individual groups, purchase histories obtained from several retailers and other providers of goods and/or services to determine targeted information and/or incentives to deliver to individuals. Purchase history and other relevant data for each individual user are accumulated at a computer that is under the control of that user and analyzed to determine which targeted information items and/or incentives to deliver to that individual user. Purchase history data in the exemplary embodiment is only maintained at the user's computer so as to increase the privacy for the user of this extensive purchase history data that was derived from multiple sources. Abridged purchase history data that does not contain information to identify the individual to which it pertains is uploaded for comprehensive analysis to develop future purchase incentive programs.

### TECHNICAL FIELD

The present invention relates to providing targeted incentives and information to individual's and more particularly to providing incentives and information based upon a household or an individual's purchasing history and other personal data, while reducing risk of invasion of privacy.

### BACKGROUND ART

Manufacturers and retailers often attempt to increase sales by influencing an individual's purchasing decisions through many means. An effective technique to encourage an individual to purchase a particular product is to provide purchasing incentives for that product, such as a “cents off” coupon. Traditional incentive distribution techniques, such as print advertising or mass mailings, have limited effectiveness. The effectiveness of mass distribution of incentives is limited in part because people tend to ignore the relatively large number of these incentives that they receive because only a small percentage are of interest to each recipient. An individual is generally required to search through the large number of advertisements and mailings he or she receives in order to find the relatively small portion that is of interest to that individual. Incentives that have mass distributions also have the disadvantage that individuals who would normally purchase the product or service being promoted also receive and benefit from the incentive, even though they would have purchased the product anyway. This results in a waste of promotional resources on individuals who are already purchasing the product or service, instead of concentrating those resources on individuals who are not already purchasing the promoted product.

An alternative to distributing incentives on a mass basis is providing targeted incentives to individuals with a known interest in the promoted product or service. This targeting of incentives allows more directed delivery of the incentives to individuals who are not already purchasing that product or service from the manufacturer or retailer providing the incentive. The interests of individuals can be determined through a number of techniques, including such techniques as accumulating purchase histories of individuals and then determining the interests and brand loyalty characteristics of those individuals by analysis of the purchase histories of each household or individual. In addition to supporting the targeting of purchasing incentives to individuals, accumulating purchase histories for individuals further supports targeted distribution of information of interest to the individual, such as recall notices or information generally of interest to individuals that purchase certain products.

Purchase histories of individuals are accumulated, for example, by identifying individuals at a Point of Sale (POS) and storing an identification of each product purchased in connection with the identification of the purchaser. Products are often identified by a Universal Product Code (UPC) that is encoded in a printed bar code on the product's packaging. This bar code is usually read by an optical scanner that is part of the POS system. The UPC may also be programmed into Radio Frequency Identification (RFID) transponder tags that are attached to each unit of product and are electronically programmed with data to uniquely identify each product and which may be extended to identify each unit of product. Antenna emit radio signals to activate the RFID tag and read from it. Antennas are the conduits between the tag and the transceiver, which controls the data acquisition and communication with the RFID tag. RFID readers may be used in place of, or in addition to, optical scanners that read printed bar codes. Individuals are identified at the POS by one of several techniques, such as by the checking account number of a check used for payment or by the purchaser's presenting a card or other token that has a bar code or other identification. An example of accumulating and analyzing individual purchase histories is described in detail in U.S. Pat. No. 5,832,457. The content and teachings of U.S. Pat. No. 5,832,457 are hereby incorporated herein by reference.

In order to allow promoters of products and services to identify individuals to whom to deliver targeted incentives, large numbers of consumers are giving away their personal data in order to receive the real or perceived benefits of targeted incentives from their suppliers. For example, it is reported that over 60% of households in the United States now carry at least one supermarket membership card that they use to qualify for targeted incentives, such as discounts on their shopping trips.

Consumer groups, such as Consumers Against Supermarket Privacy Invasion And Numbering (CASPIAN) have voiced opposition to these membership cards that are used to identify purchasers and allow the accumulation of purchase histories. CASPIAN and others warn consumers of the potential for dangerous privacy invasion and argue that the cards offer no real value to consumers in terms of savings or any other real benefit.

In addition to the privacy concerns of consumers, current systems for collecting consumer information focus on the needs of the marketers or suppliers of products and services. Consumer data is generally placed in centralized databases that are under the control of the marketer or supplier. The central accumulation of purchase history data by marketers or suppliers not only raises privacy concerns, it also impacts the ability of a consumer to access these data and to consolidate their own data for their own needs. For example, consumers typically purchase their groceries in different grocery stores and chains and there is also an increasing trend for consumers to purchase groceries from Club stores, Mass Merchandisers, and from convenience stores. Grocery retailers who have frequent shopper programs generally store purchase histories of purchases made by an individual that were only made from that retailer, and that data is not shared with other retailers. It is also unlikely that a consumer would be given access to their own data from these various retailers, even if the consumer wanted to use their purchase history data for their own purposes, such as to improve their replenishment planning, monitor their nutritional consumption, generate meal plans and menu ideas, be alerted to recalls, or simplify communication with their retailers and brands.

Accumulating consumer purchase history data that is segregated by each retailer, brand, or service provider limits the ability of even those providers to deliver relevant communication and offers to consumers because each of those providers have incomplete data on each consumer's purchase history, demographics, and life-style.

Therefore, a system is needed to overcome the above problems with the prior art by, for example, giving consumers control of their own data, allowing consumers to realize benefits from these data, and improving the quality of communication between consumers and their brands and their suppliers of all types of products and services.

### DISCLOSURE OF THE INVENTION

According to an aspect of the present invention, a method for delivering targeted incentives includes receiving a set of purchase history data at a processor under the control of a user. The method also includes receiving at least one specification of targeted information at the processor. The at least one specification includes a condition and a process for delivery of the targeted information item. The method also includes determining, at the processor and based upon the condition within the at least one specification and based upon the set of purchase history data, at least one targeted information item to present to the user.

According to another aspect of the present invention, a targeted information and/or incentive delivery system includes a data retrieval processor for receiving a set of purchase history data at the processor. This processor is under the control of a user. The targeted information and/or incentive delivery system further includes an incentive receiving processor for receiving at least one specification of targeted information at the processor. The at least one specification includes a condition and a targeted information item. The targeted information and/or incentive delivery system further has an incentive determination processor for determining, at the processor and based upon the condition within the at least one specification and based upon the set of purchase history data, at least one targeted information item to present to the user.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a system architecture diagram for an exemplary targeted information and incentive distribution system in accordance with an exemplary embodiment of the present invention;

FIG. 2 is an inter-database data flow diagram for an exemplary targeted information and incentive distribution system in accordance with an exemplary embodiment of the present invention;

FIG. 3 is a data content diagram for a targeted information and incentive definition database of an exemplary targeted information and incentive distribution system in accordance with an exemplary embodiment of the present invention;

FIG. 4 illustrates a server block diagram as used within an exemplary targeted information and incentive distribution system in accordance with an exemplary embodiment of the present invention;

FIG. 5 is a user computer block diagram in accordance with an exemplary embodiment of the present invention;

FIG. 6 illustrates a temporary database download processing flow diagram as used within an exemplary targeted information and incentive distribution system in accordance with an exemplary embodiment of the present invention;

FIG. 7 illustrates an individual user program processing flow diagram as used within an exemplary targeted information and incentive distribution system in accordance with an exemplary embodiment of the present invention;

FIG. 8 illustrates an upload abridged data processing flow diagram as used within an exemplary targeted information and incentive distribution system in accordance with an exemplary embodiment of the present invention; and

FIG. 9 illustrates a accumulate abridged data processing flow diagram as used within an exemplary targeted information and incentive distribution system in accordance with an exemplary embodiment of the present invention.

### BEST MODE FOR CARRYING OUT THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

The term “item” as used in this specification is defined to include goods, services, and other objects which an individual purchases or for which an individual exchanges value.

Preferred embodiments of the present invention will be described in detail hereinbelow with reference to the attached drawings.

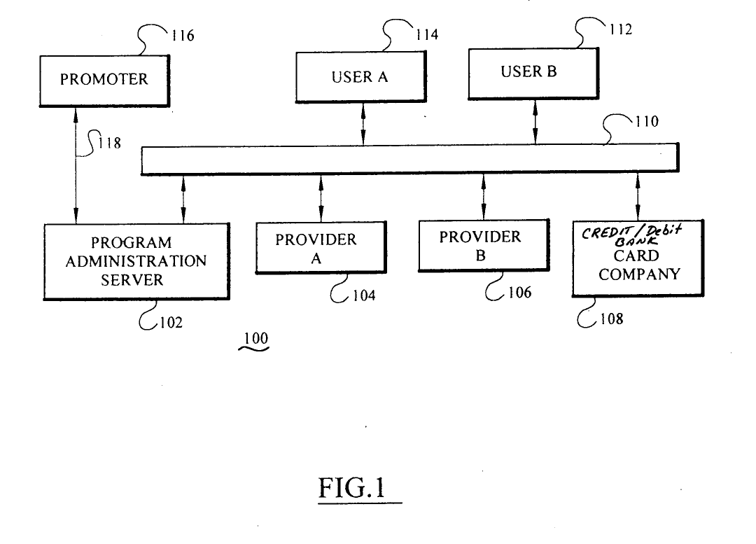

A system architecture diagram for an exemplary targeted information and incentive distribution system 100 in accordance with an exemplary embodiment of the present invention is illustrated in FIG. 1. A program administration server 102 in the exemplary embodiment is a centralized or distributed server computing system that performs centralized administration of the operation of the exemplary targeted information and incentive distribution system 100. The program administration server 102 of the exemplary embodiment is implemented as a decentralized program administration server that is distributed across multiple processors or computers that are able to be physically and geographically dispersed in order to improve reliability, redundancy and/or communications to other computers. Alternative embodiments of the present invention use a centralized server to implement the program administration server 102.

The exemplary targeted information and incentive distribution system 100 includes a number of providers, such as Provider A 104 and Provider B 106. This description of the exemplary embodiment shows only two providers to improve the clarity and understandability of this description. It is to be understood that embodiments of the present invention operate with a large and practically unlimited number of providers, including information providers, that provide purchase history data and other information to the components of the exemplary targeted information and incentive distribution system 100. It is to be further understood that using two exemplary providers in this description in now way limits the generality of the operation of this embodiment.

Providers, such as Provider A 104 and Provider B 106, are able to be any type of supplier of goods and/or services, such as grocers, mass merchandisers, specialty stores, convenience stores and service providers. Some embodiments of the present invention operate in a business-to-business (B-to-B) environment and providers are able to include wholesalers, manufacturers, transportation services and other providers that serve any particular type or types of businesses. Another particular type of information provider for the exemplary targeted information and incentive distribution system 100 are financing companies, such as credit card company 108. Financing companies are able to accumulate purchase history data for individuals by storing information describing the purchases that individuals finance or pay for through payment vehicles provided through those finance companies.

The computers, servers, and other devices that are a part of the exemplary targeted information and incentive distribution system 100 communicate via a communications network 110. The communications network 110 of the exemplary embodiment is based upon the Internet but is able to include various communications links that do not include the Internet and that connect two or more components of the exemplary targeted information and incentive distribution system 100. Communications network 110 is able to include wireless data links that utilize RF and/or infrared links that are able to include terrestrial and/or satellite based communications links. Embodiments of the present invention are able to include any suitable communications facility in the communications network 110.

The exemplary targeted information and incentive distribution system 100 includes a number of users, such as User A 114 and User B 112. Again, two users are referenced in this description to improve clarity and understandability. It is to be understood that embodiments of the present invention are able to operate with a practically unlimited number of users and using two exemplary users in this description in no way limits the generality of operation of this embodiment. The users in this embodiment, such as User A 114 and User B 112, utilize computers and/or other types of processors or display devices that are possessed and controlled by the individuals to whom targeted incentives and information are to be delivered. Computers and/or processors used by users in the exemplary embodiment include, but are not limited to, desktop and laptop computers used in a person's home. Computers and/or processors used by users also may include portable wireless computing devices that may include wireless communications facilities, such as laptop computers, tablet computers, handheld personal digital assistants (PDAs) and cell phones. Users of alternative embodiments are also able to use computing facility that are remote from the user and shared by multiple users. These embodiments use access control procedures and processing to ensure that data for each user of the remote computing facility is secure and not accessible by anyone except the individual user to whom the data pertains.

A user in the context of the exemplary embodiment is able to consist of a single individual or all members of one household or of one consenting group of individuals. A further example of a user includes an institution, such as a school, that desires to receive special offers and nutritional data based upon all purchases made for that institution. Such an institution is able to configure a single account for the institution. Further examples of users include a single household that has set up sub accounts for individual household members. Such a household would receive information based upon their entire purchase history, but individual members of the household would be able to view just their data via their sub-account.

The exemplary targeted information and incentive distribution system 100 further includes promoter systems, such as Promoter 116. Promoters in the context of the present invention include any provider of a targeted purchase incentive or targeted information. A Provider and a Promoter may represent different functions of the same entity. Promoters, such as Promoter 116, typically communicate with the program administration server 102. Promoters are able to communicate with other components of the exemplary targeted information and incentive distribution system 100 either via the communications network 110 or via an alternative communications link such as the alternative program administration server link 118 that is shown, which can include telephone, facsimile, written mail or other communications modes. Promoters have an ability to enter their own promotions and information into the system via an interface with the program administration server 102.

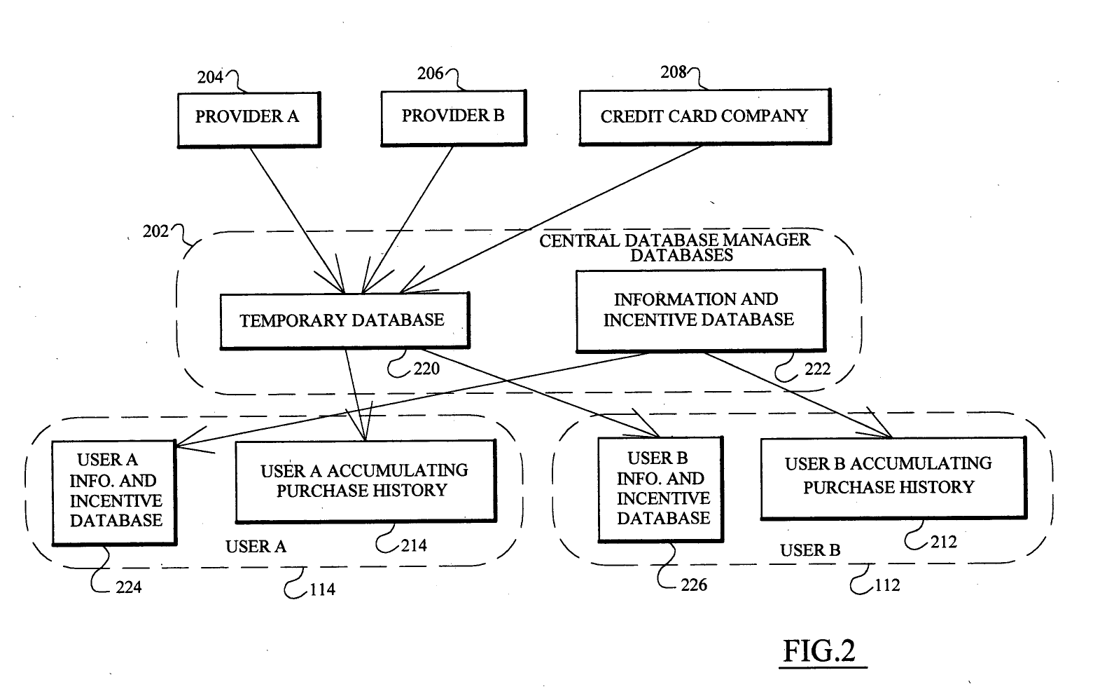

An inter-purchase history database data flow diagram 200 for an exemplary targeted information and incentive distribution system in accordance with an exemplary embodiment of the present invention is illustrated in FIG. 2. The exemplary embodiment includes a number of databases that are maintained on a number of computing systems that are distributed across the targeted information and incentive distribution system 100. The inter-database data flow diagram 200 illustrates these databases and the data flow interconnections between those databases. The data flow for information and incentive distribution to the user computers is also shown in this diagram.

The exemplary embodiment of the present invention includes two databases that are managed by a Central Database Manager (CDBM) 202, which is operated within the program administration server 102. The CDBM 202 of the exemplary embodiment maintains a Temporary Database 220 and an Incentives and Information Database 222. The Incentives and Information Database 222 contains definitions of incentives and/or information that are to be provided to individual users if that user satisfies conditions that are associated with that particular piece of information and/or incentive. Some embodiments of the present invention operate by communicating purchase history data from providers to user computers. The central database manager 202 of the exemplary embodiment includes a Temporary Database 220 that receives, from retailers or other suppliers, consumer Universal Product Code (UPC) level retail transaction purchase history data, including the dates of the purchases, for purchases made by an individual. The exemplary embodiment further supports delivering purchase transaction total values to the central database manager. Examples of receiving transaction total information only data includes receiving credit or debit card purchase data from the credit or debit card clearing house. The temporary database 220 of the exemplary embodiment temporarily stores that data until the individual users subsequently download that data to their computers. The temporary database 220 of the exemplary embodiment of the present invention allows flexibility on the part of users to connect to and log onto the program administration server 102 to retrieve data associated with the targeted information and incentive distribution system 100.

In the operation of the exemplary embodiment, purchase histories for individual users are accumulated by providers, such as Provider A 104 and Provider B 106, as well as financing companies such as credit card Company 108. Credit card companies, such as credit card Company 108, is able to be any payment service, including conventional credit cards, debit cards, signature cards, etc. These providers maintain their own databases, such as Provider A database 204, Provider B database 206 and credit card company database 208. The databases maintained by the providers of the exemplary embodiment are able to support the specialized operations of those providers. In addition to supporting the operation of the providers, these databases are configured to download purchase history data to the program administration server 102 for storage into a temporary database 220, as is described below. The operation of the exemplary embodiment is able to be configured to allow periodic, non-periodic or continuous communication of purchase history data from providers to the program administration server 102 as is best suited to the particular provider and/or other operational factors. Providers are able to further assist in protecting the privacy of user data by deleting user purchase histories from their databases after transmission of these data to the program administration server 102.

As an alternative to electronically transmitting data from a provider to the temporary database 220, and then ultimately to a user, some embodiments allow a user to electronically collect purchase transaction data at the point of sale immediately after, or even during, the transaction. Such embodiments allow a user to provide a smart card, a Universal Serial Bus (USB) drive, a flash memory module, or other electronic data storage media, to a point of sale terminal and the transaction data is then stored into that user provided media. The user provided media is then retained by the user, and inserted into, for example, the user's computer in order to download the purchase transaction data and allow the user's computer to receive that purchase history data. Similarly, purchase transaction and purchase history data can be electronically communicated by e-mail or other directed electronic communications from a provider to the user's computer. Embodiments of the present invention are able to incorporate any suitable communications method to convey purchase transaction and/or purchase history data from a provider to the user's computer or to a computer under the user's control. Such purchase transaction data is able to include descriptions of each item purchased or just the total purchase amount for the transaction, along with an identification of the provider from which the purchase was made.

Providers may be given access to aggregated purchase histories from the Central database manager 202 to then use to support the specialized operations of these Providers. These aggregated purchase histories do not contain data that is identifiable with an individual user. Providers are able to identify themselves by displaying indicia that identifies them as participating in the operation of the system of the exemplary embodiment. Such indicia include trademarks associated with the exemplary embodiment and are able to be displayed on a provider's advertising, promotional or other materials, in a physical business location and/or on the provider's web site.

The Central database manager 202 further maintains an information and incentives database 222. The information and incentives database 222 stores specifications for information and incentives that are to be provided to individual users who satisfy conditions that are associated with each incentive or item of information, as is described below. Incentives are determined in the exemplary embodiment according to the marketing, promotional and/or other needs of promoters that are providing the information and/or incentive. The effectiveness of incentives that are directed to particular consumer interests and purchasing patterns is also able to be determined and further refined through analysis of an abridged purchase history data, as is described below. Users may also request that specific information be provided routinely, such as for example, nutritional information. Users may also block message delivery from specific promoters or from all promoters.

Each user computer, such as User A 114 and User B 112, in the exemplary embodiment maintains two local databases. User computers maintain a User Purchase History Database, such as the User A Accumulating Purchase History Database 214 maintained by the User A Computer 114 and the User B Accumulating Purchase History Database 212 maintained by the User B computer 112. Each user computer in the exemplary embodiment also maintains a local incentive and information database, such as the User A Incentive and Information database 224 that is maintained by the User A computer 114 and the User B Incentive and Information Database 226 maintained by the User B computer 112. The processing performed by the exemplary embodiment to use and maintain the data in these databases is described in detail herein.

In order to facilitate distribution of targeted information and incentives, the exemplary embodiment defines consumer “clusters” with which individual user of the exemplary embodiment are associated. A cluster identifier is also associated with each of these clusters. Clusters in the exemplary embodiment are defined to serve the needs of promoters of products and services and are based upon criteria such as combinations in the individual's purchase histories, demographic data, and lifestyle data. Consumer clusters provide an easy way to identify consumers with special or particular interests so that targeted information and/or incentives can be delivered to consumers who have those particular interests. Cluster identifiers for each cluster to which an individual belongs are stored in that user's computer. Users may have the option to add or remove themselves to or from specific clusters.

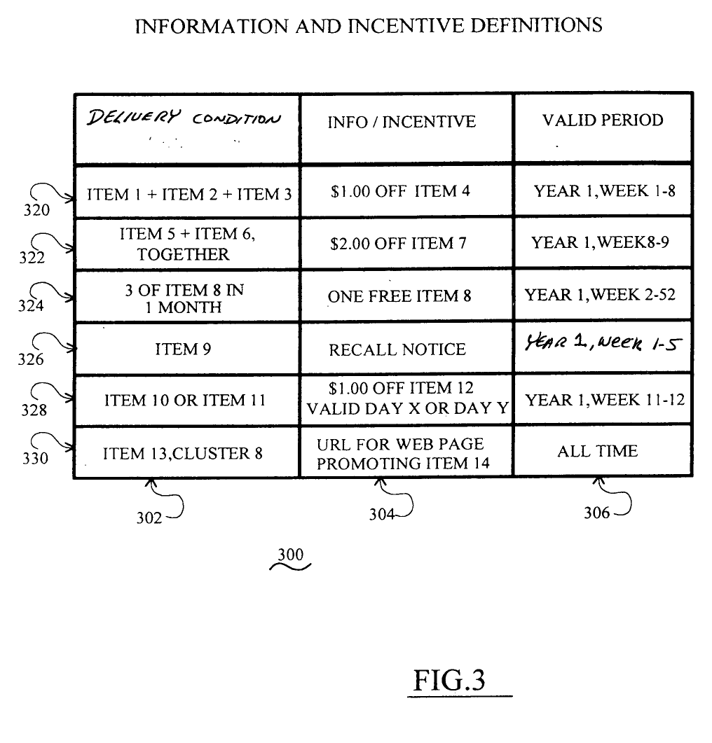

A data content diagram for an information and incentive definition database 300 of an exemplary targeted information and incentive distribution system in accordance with an exemplary embodiment of the present invention is illustrated in FIG. 3. The information and incentive definition database 300 is created, distributed and maintained by the Program Administration Server 102. Data elements for the information and incentive definition database 300 are defined by the processing of the Program Administration Server 102 and reflect targeted incentives or information that are to be provided to individuals based upon satisfied pre-conditions for the delivery of such incentives or information, such as being assigned a cluster identifier, prior purchases of one or more items, and/or a value range for one or more transactions made by that user. Each user computer in the exemplary embodiment maintains a local copy of the incentive definition database 300, such as the User A Incentive and Information Database 224 maintained by User computer A 114, and processing performed by each user computer determines incentives and information that are to be provided to the individual user associated with that computer, as is described herein.

The program administration server 102 of the exemplary embodiment maintains a central information and incentives database 222 and distributes to user computers, such as User A 102, the current information that is stored in that database. The program administration server 102 of the exemplary embodiment is able to be configured to distribute the entire incentive and information database 222 or to distribute only updates that are periodically made to that database.

The incentive and information definition database 300 of the exemplary embodiment contains three types of data that are each stored in one of the three “columns” of the database. The delivery condition column 302 is able to contain a specification of one or more conditions for the delivery of information or incentives associated with that condition. Delivery conditions specified in the delivery condition column 302 include one or more of purchase history data, or specified characteristics for the user, such as demographic information, life-style data, or survey response data. The Information/Incentive column 304 describes information and/or incentives that are to be provided to individuals who have satisfied the conditions for that row of the incentive and information database 300. The incentive and information database 300 of the exemplary embodiment further has a “Valid Period” 306 column that defines the time period in which an individual is required to satisfy the delivery condition column 302 for that row in order to qualify to receive the information and/or incentive specified in that row.

In the exemplary embodiment, an individual who has purchased the one or more items specified in the delivery condition column 302, within the time range specified in the valid period 306 column, is offered the information and/or incentive specified in the information/incentive column 304 for that row. The exemplary embodiments allows multiple items to be specified in the delivery condition column 302 and further allows a specification within that column of whether the items must be purchased together. If it is not specified that the items are required to be purchased together, the processing of the exemplary embodiment allows the user to purchase those items at different times within the valid period specified in the Valid Period column 306 and still receive the incentive or information. The processing of individual user computers in the exemplary embodiment determines if the individual associated with that computer has purchased the items specified in the delivery condition column 302 by analysis of the purchase history database.

As an alternative to or in addition to a list of items to purchase, a cluster identifier is also able to be specified in the delivery condition column 302 of an information and incentive definition entry. If an individual user is assigned a cluster identifier that is specified within a purchase history column, that user satisfies that requirement and is qualified to receive the information or incentive if the other requirements for that row are satisfied. This allows information, such as a targeted message, to be delivered to all of the individual users that belong to a particular cluster.

Examples of the targeted information and incentives delivered by the exemplary embodiments of the present invention are illustrated in the exemplary incentive and information database 300. A first row 320 defines a targeted incentive, defined within the information incentive column 304, as “$1.00 OFF ITEM 4.” A user of the exemplary embodiment of the present invention qualifies for this incentive by purchasing, as defined in the delivery condition column 302 for that row, one each of ITEM 1, ITEM 2 and ITEM 3. These items are required in the exemplary embodiment to be purchased within the valid period, as defined by the Valid Period 306 column for that row, which is specified as the time period of Year 1, Weeks 9 through 12. These items are not required to be purchased in the same transaction, but are able to be purchased in separate transactions during the valid period.

A second row 322 describes a second targeted incentive of “$2.00 OFF ITEM 7” if the user purchases one each of ITEM 5 and ITEM 6 “together” within the valid period of Year 1, Week 8-9. The “together” specification for this delivery condition specifies that all of the times in the list have to be purchased in the same transaction. This is in contrast to the other rows which do not specify that the purchases have to occur together and purchasing of the items in the same or in different transactions, if they all occur during the valid period specified in the valid period column 306, will satisfy the purchasing conditions for that row and the information or incentive of that row will be offered to that user.

Another example of a targeted incentive is a third targeted incentive that is shown in a third row 324, which defines receiving ONE FREE ITEM 8 if the purchaser purchases three of item 8 within year 1, week 2-52. The third targeted incentive allows the promoter of item 8 to give individuals an incentive to purchase multiple units of a particular item without requiring the individual to purchase all of the items in a single transaction.

A fourth row 326 indicates that purchasers of ITEM 9 who purchased that item from any retailer and during the time specified, i.e., “YEAR 1, WEEK 1-5” in this example, are to receive a recall notice. Recall notices are able to be conditioned upon the item being purchased from a specific retailer in order to support retailer specific recalls. Additionally, some product identification techniques, such as RFID technology, allow the retailer who sold specific units of the item to be linked in the database with the purchase identification to create a specialized code that is suitable for more advance purchase tracking. As an example of the use of RFID technology, manufacturers maintain databases that indicate which retailer received, for example, specific cases and specific units of a particular product. When a retailer sells a RFID coded unit of product, the retailer is able to log the sale of that specific unit of product. The logged data includes not just the brand, flavor and type of the product, but also the specific unit of, for example, Pillsbury White Cake mix, 16 oz. The RFID encoded data includes the UPC for the product and also the time (instant) that the product was packed, and where it was packed. This data is able to be stored into a database in association with the product identifier, even in embodiments that do not change the data encoded into the RFID tag itself. The valid period that is specified in the Valid Period column 306 allows recall notices to be selectively provided only to individuals who purchased products during a particular time, such as prior to removal of defective products from store shelves. A fifth row 328 provides an incentive of $1.00 OFF ITEM 12 with an “expiration date” specified as a valid period for the incentive of DAY X through DAY Y. A sixth row 330 indicates that a user is to be provided with a Universal Resource Locator (URL), such as a World Wide Web page, that provides information about ITEM 14 if the individual has purchased ITEM 13 and is assigned to Cluster 8. A short description of the provided URL is also provided to the individual. ITEMS 13 and 14 in this case may be chosen, for example, based on a correlated interest for those items, especially if the individual is assigned to the specified cluster. For example, a purchaser in a cluster defined as a pet owner who has recently purchased a litter box, which is ITEM 13 in this example, would likely be interested in a new type of cat litter, which is ITEM 14. The provided URL provides a description, and an optional incentive such as a coupon, for that new cat litter.

Other data that is able to be provided in the information/incentive 304 column in the exemplary embodiment includes a notification of coupons and/or discounts that are available from conventional sources, such as the Sunday newspaper, magazines, in-store coupon dispensers or fliers. Notifications of in-store specials can also be provided. Notifications provided in the information/incentive 304 column are able to be related to products and services of many different types, such as travel, services and other items. The information/incentive 304 column is also able to specify a reference to user manuals, manufacturer warranties, offers for extended warranties, and notices, discounts or other incentives for upgrades or out-of-warranty repair for items, such as appliances. Nutritional information about purchased products is also able to be specified. The processing of some embodiments of the present invention combine nutritional information provided within the information and incentive definitions, and/or nutritional information obtained from other sources, such as a USDA nutritional database, into comprehensive nutritional information for combinations of some or all items purchased by the individual user.

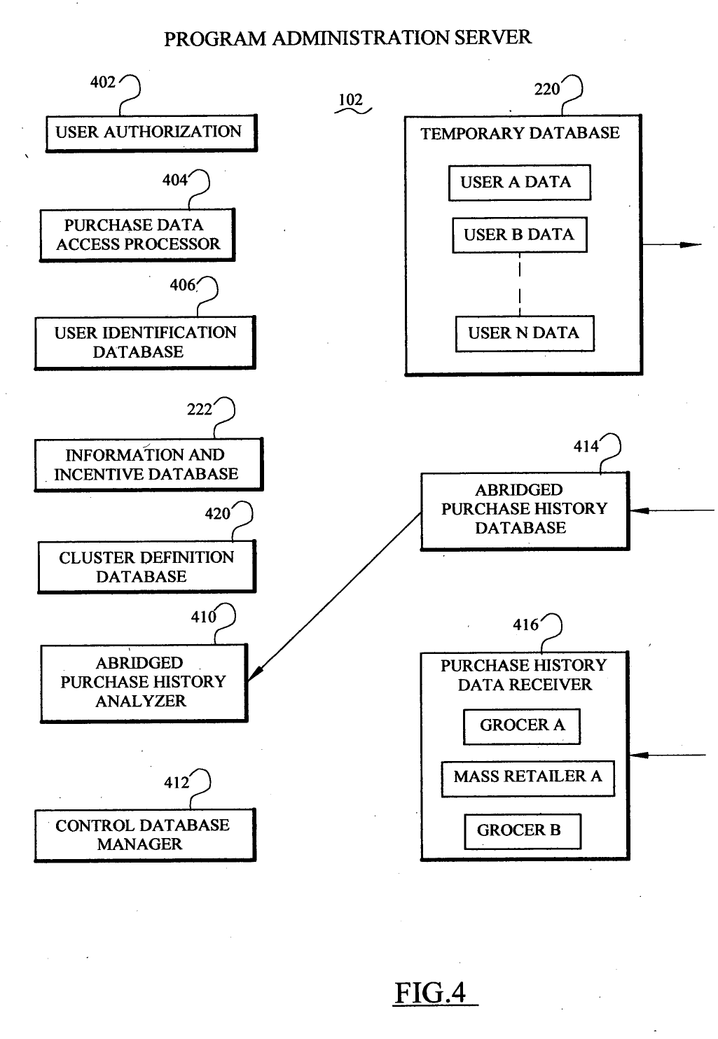

A program administration server 102 block diagram as used within an exemplary targeted information and incentive distribution system in accordance with an exemplary embodiment of the present invention is illustrated in FIG. 4. The Program Administration Server 102 is described herein as a single processing entity in the interest of simplifying the explanation of the exemplary embodiment for ease of understanding. The Program Administration Server is able to be effectively divided among multiple processors that are collocated or geographically dispersed in order to enhance reliability and communications efficiencies.

The program administration server 102 of the exemplary embodiment includes a user authentication module 402. The user authentication module 402 of the exemplary embodiment processes user account names and encrypted passwords that are transmitted by individual users when logging into the system. The user authentication module 402 further maintains account status information for each individual user using the system. Some embodiments of the present invention incorporate various user authentication techniques, as are known to ordinary practitioners in the relevant arts.

The program administration server 102 includes a purchase data access processor 404 that provides security processing to limit access to the purchase data stored within the temporary database 220. The purchase data access processor 404 ensures that individual users are only able to access and retrieve their own purchase history data, and not data associated with any other user. The program administration server 102, includes a user identification database 406. The user identification database 406 stores a list of purchaser identifications that are used by different providers to identify each user, along with a mapping of these purchaser identifications to the user account for the corresponding user on the targeted information and incentive distribution system. The purchaser identifications used by providers in the exemplary embodiment include frequent shopper identification numbers, credit card numbers, checking account numbers and/or any other identifiers collected by the retailers or other providers supplying purchase history data to the targeted information and incentive distribution system. Purchaser identification data is provided to the program administration server 102 by the user in the exemplary embodiment, for example, during registration or updating of personal information. Some embodiments of present invention allow for automated acceptance of purchaser identifiers, such as a list of frequent shopper numbers from a particular retailer, in order to simplify the addition of a provider into the targeted information and incentive distribution system.

The program administration server 102 of the exemplary embodiment includes a central database manager 412 that maintains the temporary database 220, the cluster definition database 420, and the information and incentive database 222. The central database manager 412 of the exemplary embodiment manages the databases maintained within the program administration server 102 and also manages updating of the databases that are stored on the user computers.

The program administration server 102 of the exemplary embodiment includes an abridged purchase history database 414 that receives and accumulates abridged purchase history data from user computers. The abridged purchase history data is an accumulation of purchase history data and incentive redemption data for the users of the targeted information and incentive system. Information included in the abridged purchase history data in the exemplary embodiment includes: Total unit sales by UPC, Brand, Category, Department, Retailer, Manufacturer; Total dollar sales by UPC, Brand, Category, Department, Retailer, Manufacturer; Total statistical case sales by UPC, Brand, Category, Department, Retailer, Manufacturer; Weighted purchase intervals (e.g. days to use 1 gallon of orange juice, even though orange juice may be purchased in varying container sizes), coupon usage, Promotion response, Demographic data, Life-style data, and Zip code.

The abridged purchase history data does not contain any information to identify the user and does not include any personal identification data about the user such as name, address, telephone number, social security number, credit card numbers, or membership numbers that are linked to these personal data. The data in the abridged purchase history database 414 is analyzed by the abridged purchase history analyzer 410 to evaluate previously offered incentives and analyze purchase history data to assist in the development of new purchase incentives. The abridged purchase history analyzer 410 analyzes abridged purchase history data for multiple users. The abridged purchase history analyzer 410 of the exemplary embodiment accesses user abridged purchase history data and other user characteristics, such as user specified tastes, demographics, lifestyle and other information in order to determine items to recommend to users with similar characteristics.

The program administration server 102 of the exemplary embodiment has a purchase history data receiver 416 that performs communications with the various providers that supply purchase history data to the program administration server 102. The purchase history data receiver 416 receives the data from the various providers, such as retailers, credit card companies, etc., and uses data stored in the user identification database 406 to determine the corresponding user account for the received individual user's data. The data is then stored in the temporary database 220 in association with the proper individual user.

Consumer cluster definitions stored in the cluster definition database 420 define the characteristics to be used to determine if a cluster identifier is to be assigned to an individual user, as is defined herein. More than one cluster identifier is able to be assigned to an individual user.

Further embodiments of the present invention also collect abridged personal history data from the user computers. This abridged personal history data is provided by the user of the particular user computer. The user computer is under the control of the user with whom the data is associated and this personal data is not available to other users except as described herein. This personal data includes demographic data, life-style data and other personal data. This personal data is processed so as to remove information that personally identifies the user of the computer, such as the user's name, address, bank card and membership numbers, and other such data. The user provided personal data that has had all personal identification data removed is referred to as an abridged personal history data set. A random number used by the targeted information and incentive distribution system to identify the user computer, but not the individual, is included in the abridged personal history data set to allow correlations between abridged data sets that are received at different times. Embodiments that allow users to remotely access user computers utilize similar random numbers to identify the user's account and thereby protect the user's privacy.

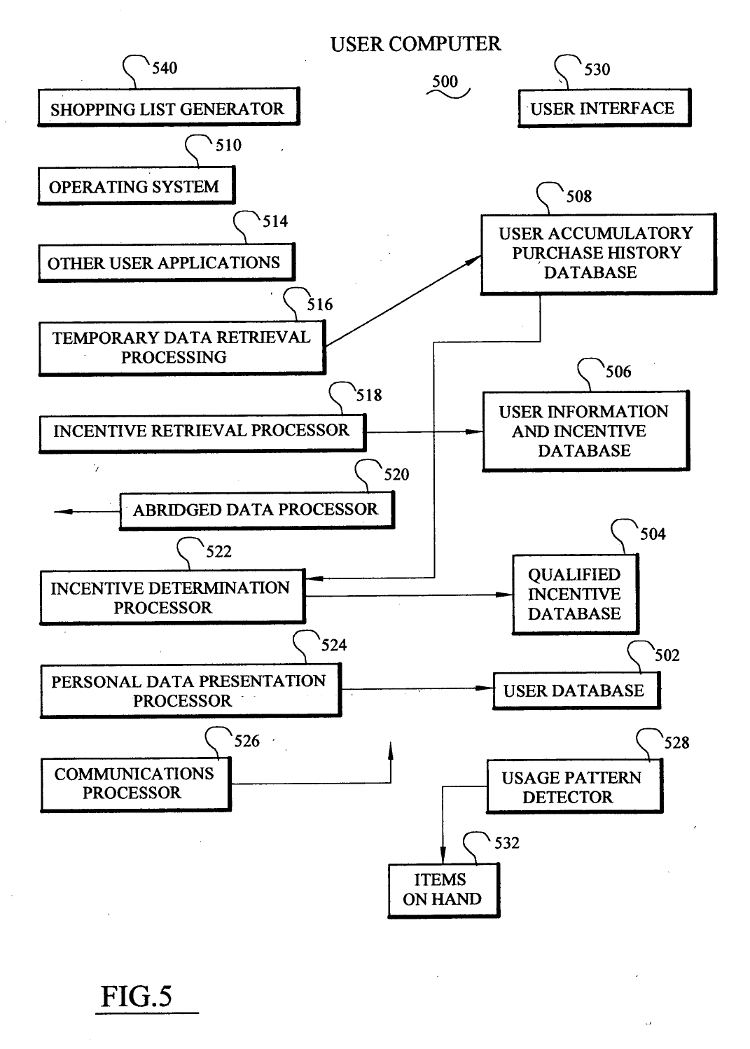

A user computer 500 block diagram in accordance with an exemplary embodiment of the present invention is illustrated in FIG. 5. The user computer 500 of the exemplary embodiment is typically located in the user's home or workplace and is under the physical control of the user. Some embodiments of the present invention utilize user computers that are remote from the individual users, some of which support serial or simultaneous use by multiple users. These embodiments incorporate security features to ensure that data for each user is protected and that individual users are able to only access his or her data.

The user computer 500 of the exemplary embodiment includes software that is not directly a part of the targeted information and incentive distribution system. The conventional operating system 510 and other user applications 514 represent these other software items. The user computer 500 has a user interface 530 that allows the user to enter data and observe output data produced by the operation of the components of the targeted information and incentive distribution system.

The components that implement functions of the targeted information and incentive distribution system and that are contained within the user computer 500 are described below. These software components are able to be distributed via several methods, including via removable data storage media such as CD-ROM, DVD, floppy disk, etc. Electronic distribution via on-line servers is another means used to distribute the software components that operate on the user computer 500. User computer software of the exemplary embodiment is able to be branded by a distributor or retailer so as to associate the targeted information and incentive distribution system with that distributor or retailer. Such branded software is able to include specialized features, such as special capabilities for communications between the branding entity and the user computer 500. Once software components are installed on a user computer 500, updates to software operating programs, as well as configuration and other data, are able to be readily downloaded from a server and applied to the installed software. Such software updates are also able to be automatically initiated.

The user computer 500 includes a temporary data retrieval processing 516 component that operates to retrieve data from a remote server, such as the Program Administration Server 102 and to store that data into the user accumulating purchase history database 508. Individual consumer purchasing data in the exemplary embodiment is generally accumulated and stored for a period of several years. The operation of the temporary data retrieval processing 516 is described below.

An identification token is generally required to be presented during purchase transactions for which purchase history is to be stored in the temporary database of the program administration server 102 in order to allow the purchase data to be properly associated with the correct user. An alternative that is supported by the exemplary embodiment includes having a provider, such as retailer, print an identifying code, such as a bar code or alphanumeric code, on the receipts and allowing the user to enter that identifying code into the user computer 500. In the exemplary embodiment, this identifying code includes a field that allows the provider to be uniquely determined. The temporary data retrieval processing 516 component then contacts a database provided by that retailer to automatically retrieve the UPC level purchase detail for that transaction. This allows the user to make purchases without presenting an identifying token during the transaction and still automatically retrieve purchase transaction data. Some embodiments allow a Personal Identification Number (PIN) to be entered during a purchase transaction that produces such a receipt, and the same PIN is supplied during the automatic download process.

The user computer 500 has an incentive retrieval processor 518 that retrieves some or all of available information and incentive definitions from a remote server, such as the program administration server 102. The incentive retrieval processor 518 stores information and incentive definitions into the user information and incentive database 506, as is described herein. The user computer 500 has an abridged data processor 520 that accepts data from the user accumulating purchase history database 508 and removes data that personally identifies the user. The abridged data processor 520 further performs processing to communicate the abridged purchase history data to a remote server, such as the program administration server 102.

The information stored in the user information and incentive database 506 of the exemplary embodiment includes the information and incentive definition database 300. In addition to the information contained in the information and incentive definition database 300, an additional data column is provided that contains an indication that allows the particular user to block messages or incentives from all or specific Promoters.

The user computer 500 of the exemplary embodiment has a usage pattern detector 528 that analyzes data within the user accumulating purchase history database 508 to determine product usage patterns for the individual user. The usage pattern detector 528 determines usage patterns of consumable products, such as toothpaste, dairy products, etc., and alerts the user when replenishment of these items is expected. Based upon these determinations, the usage pattern detector 528 determines and maintains an estimation of the items that the individual user has on hand and stores this estimation into the Items on Hand database 532. Based upon determined usage patterns, the usage pattern detector 528 can then estimate when those items will need to be replenished based upon, for example, observed periods between purchases of those items in the past. Recommended items are also suggested to a user based upon user specified characteristics, such as tastes, demographics and/or life-styles. Such item recommendations are based upon, for example, items purchased by users who specified similar tastes, demographics and/or life-style characteristic information.

The usage pattern detector 528 of the exemplary embodiment allows the user to flag purchases that should not be used to determine replenishment needs, such as items purchased for others or purchases for a party or special event. The usage pattern detector 528 of the exemplary embodiment further allows specification of household changes, such as new babies, a child that leaves for school, a child that is home for vacation and when the family leaves on vacation. As new downloads of purchase history data are received, those downloads are used to update the Items on Hand database 532.

The user computer 500 of the exemplary embodiment includes a shopping list generator 540. This shopping list generator 540 allows the user to enter items of the user's choosing, including items for which targeted purchasing incentives are offered. The shopping list generator is able to be configured to automatically suggest for addition to a shopping list such items as seasonal items or other items based upon a user selected upcoming event, such as a child's birthday party. The shopping list generator 540 of the exemplary embodiment is able to be updated from the program administration server 102 to modify the suggested items to be added to a shopping list.

In the operation of the user computer 500, the user is able to select items that are indicated as needing replenishment, as determined by the usage pattern detector 528, and have those selected items automatically added to the shopping list generated by the shopping list generator 540. The shopping list generator 540 of the exemplary embodiment is further able to present stored recipes to the user that the user is then able to select and have the related ingredients added to the shopping list. The suggested shopping lists that are suggested based upon observations by the usage pattern detector 528, seasonal suggestions, meal and snack preferences specified by the user, and other data are then modified according to data stored in the Items on Hand database 532. The proposed shopping list is then presented to the user and the user is able to add or delete items from these proposed lists prior to finalizing the list for shopping. Once a finalized shopping list is prepared to the satisfaction of the user, the user of the exemplary embodiment is able to sort the list, for example, by category or department, and then print the list or optionally transmit the list to a selected provider for fulfillment. This list is also able to be transmitted to a cell phone or PDA for reference while shopping. Providers selected to receive the list are able to include Internet retailers, area stores that will gather the items on the shopping list for pick-up or delivery to the user, and other types of providers. The list is also able to be transmitted to a retailer that will print the list along with promotions or incentives sponsored by that retailer when the user presents an identification at the retailer. A printed shopping list is also able to be produced with an optically readable symbol, such as a bar code, that allows the list to be recognized at check-out for various reasons, such as to apply one or more discounts to the transaction.

The Shopping list generator 540 of the exemplary embodiment is further able to utilize the data maintained in the Items on Hand database 532 to select recipes to present to the user. Recipes can be selected based upon minimizing the use of items that are not estimated to be on hand. The shopping list generator 540 then adds items that are not estimated to be on hand, if any, to the shopping list. If recipes are available that only require items that are on-hand, those recipes can be provided to the user without a shopping list. Recipes are also able to be selected based upon items that are on special at one or more retailer, as determined from information received by the user computer 500. The shopping list generator 540 of the exemplary embodiment further allows the user to specify the number of persons at the meal and allows the selection of options for serving different meals at the same occasion, such as in a situation of family members with special dietary needs or who eat at different times.

The shopping list generator 540 of some embodiments of the present invention store lists of related items that can be suggested to the user because they are related to goods and/or services that were entered into a shopping list by the user. These lists of related items are able to be generated by analysis of purchasing patterns performed by the abridged purchase history analyzer 410, by product promoter or by other means. These lists of related items are useful, for example, in the context of planning for special events, such as parties and/or social gatherings, or for planning travel.

The shopping list generator 540 of some embodiments of the present invention is further able to suggest items to purchase based upon any special needs of one or more family members based upon at least one characteristic of those family members. For example, the shopping list generator 540 is able to store data concerning foods to address dietary limitations associated with diabetes, high cholesterol, high blood pressure and other health issues.

Some embodiments of the present invention receive information describing the sales price of items from a number of retailers or other providers of goods and/or services. This price information is able to include conventional “brick and mortar” retailers, Internet retailers, catalog retailers, and/or any providers of goods and/or services. The shopping list generator 540 is then able to compare the prices for the items in a proposed or finalized shopping list at these various providers and notify the user of the provider that has the lowest price for each item or of a single provider that has the lowest total cost for the entire shopping list.

The shopping list generator 540 of the exemplary embodiment is further able to be used to plan for purchases or expenditures that are expected by a user and/or the user's family. Travel plans, for example, are able to be specified into the shopping list generator and associated items, such as air travel and car rental, and/or restaurant reservations and food purchases for trips specified as by automobile, as well as other information are suggested for addition to the shopping list. A user is also able to enter a specific project, such as spring cleaning, washing a car or gardening, and a suggested shopping list is then produced. Shopping lists for parties can also be suggested, including items based upon a theme for the party. Game ideas, weight loss diets, special needs foods, child care information, chat rooms given determined interests of the user, household repair, home decorating and garden/landscaping ideas are other areas of suggestions that some embodiments of the exemplary embodiment are able to provide. The suggestions are provided based, at least in part, on data contained within the user information and incentive database 506.

The user computer 500 of the exemplary embodiment has an incentive determination processor 522 that processes the data within the user information and incentive database 506 and the user accumulating purchase history database 508 to determine which targeted information and/or incentives the individual user is qualified to receive. The incentive determination processor 522 processes the data in the user accumulating purchase history database 508 to identify multiple entries that describe the same purchase and attempts to correlate those entries. An example of such multiple entries that describe the same purchase is one entry describing the retailer's transaction data and another entry describing the credit card company's charge information for the same transaction. The retailer's transaction data in the exemplary embodiment describes each item purchased, while the credit card company's charge information includes only the total transaction cost billed to the credit card. Despite the differences in the detail of data between these two entries, the incentive determination processor 522 of the exemplary embodiment identifies and integrates this correlated information.

Information and incentives that the individual user is qualified to receive, as determined by the incentive determination processor 522, are stored in a qualified incentive database 504. Incentive information in the exemplary embodiment is also able to be electronically transferred to a retailer's POS system so that the incentive is able to be applied when the user makes a qualifying purchase at that retailer.

The incentive determination processor 522 of the exemplary embodiment further includes a cluster definition receiver component that receives cluster specifications from the program administration server 102. Cluster specifications specify purchase history, demographic data and other data that have to be satisfied for a user to be associated with a cluster. A cluster determination processor that is part of the incentive determination processor 522 determines if the individual user satisfies the requirements of any of the received cluster specifications. If the user satisfies the requirements of any of the received cluster specifications, the identifier for that one or more cluster specification is stored in the user database 502, which is described below. When a targeted information or incentive definition that contains a cluster identifier is received, the incentive determination processor 522 determines if the user is assigned that cluster identifier and will then provide the information or incentive if other conditions for that information or incentive are met. This allows a promoter to communicate targeted messages to individuals in certain clusters to whom that information is presumed to be of interest.

The user computer also has a communications processor 526 that performs communications processing for the user computer 500, including the secure communications between the user computer 500 and the program administration server 102. The communications processor 526 allows messages to be communicated to the user computer and provided to the user through the processing of the exemplary embodiment without the use of conventional e-mail and therefore received by the user without exposure to mass e-mailings, such as spam e-mail.

A User Data database 502 stores personal and demographic information about the user, that is able to be used as a further qualification or requirement to receive information or incentives specified in the targeted information and incentive definitions. The User Database 502 of the exemplary embodiment is further able to receive and store information to support operation of the various modules of the user computer 500. The user computer 500 is able to receive messages that are directed to all users or targeted to specific users. The user database 502 stores these messages and provides for the display of these messages to the user, as is described below. User data stored in the user database 502 is further able to include the user's status in other reward programs, such as frequent flyer travel programs and the like. Data concerning reward program status is automatically retrieved by the exemplary embodiment through conventional World Wide Web interfaces or through cooperative communications facilities established for the targeted information and incentive distribution system. The user database 502 is further able to store helpful information to simplify home management, such as stain removal and other cleaning tips, that the user can access at will. This helpful information is able to be stored directly in the user database 502 or an indicator of the information, such as a reference or hyperlink, is able to be stored and provided.

The user computer includes a personal data presentation processor 524 that presents information to the user. The personal data presentation processor 524 allows display of qualified incentives, which are incentives that the user is qualified to receive based upon purchase history and/or other criteria, as well as directed communications to the user. The exemplary embodiment of the present invention supports private communications between the program administration server 102 and user computers. This facility allows communications between the users of the system and providers/promoters that is accomplished without spam e-mail or pop-up advertising as is usually encountered in other types of electronic communications. Such spam and pop-up free communications provides a distinct advantage to users of this system relative to conventional communications modes. Information communicated to users includes surveys that the user is able to complete and return, via the secure communications system 110. Targeted requests for product samples can also be sent to users, who can then easily return the request for fulfillment.

Further embodiments of the present invention include a user computer 500 that allows the user to provide personal data. The personal data accepted by the user computer includes demographic, life-style and other personal data. Personal data obtained by completion of an opinion or habits survey can also be accepted by the user computer. The personal data accepted by the user computer is processed by a data reducer so as to remove information that personally identifies the user of the computer. Personal identification data, such as the user's name, address and other identifying data, for example, are removed. The user provided personal data that has had all personal identification data removed is referred to as an abridged personal history data set. A random number used by the targeted information and incentive distribution system to identify user computer, but not the individual, is included in the abridged personal history data set produced by some embodiments to allow correlations between abridged data sets that are received at different times. Once the abridged personal history data set is produced, a data transmitter in the communications processor 526 transmits the abridged personal history data set to a remote analysis system, such as the program administration server 102.

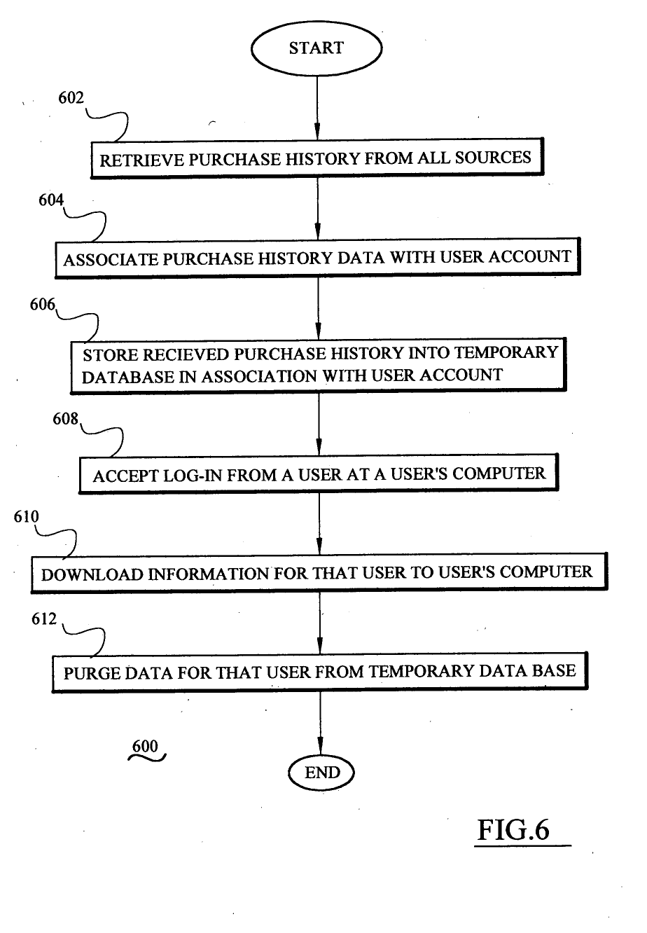

A temporary database processing 600 flow diagram as used within an exemplary targeted information and incentive distribution system in accordance with an exemplary embodiment of the present invention is illustrated in FIG. 6. The temporary database processing 600 of the exemplary embodiment is performed by the program administration server 102 and is used to provide a central location for the temporary accumulation of purchase history data to facilitate downloading of that data by individual users who are participating in the targeted information and incentive program implemented by the exemplary embodiment.

The temporary database processing 600 flow of the exemplary embodiment begins by retrieving, at step 602, purchase history for all individuals participating in the targeted information and incentive distribution program implemented by the exemplary embodiment of the present invention. Only purchase history data for individuals that are enrolled in the targeted information and incentive distribution system is retrieved from the providers. Purchase history data is retrieved from all sources, such as from retailers, service providers, credit card companies, and so forth. Purchase history data is retrieved from each provider according to techniques adapted to the needs and operations of that provider. The exemplary embodiment is able to be configured to periodically retrieve purchase history data from providers or to accept purchase history data that is autonomously,transmitted to the program administration server 102. The purchase history data that is retrieved also has information that provides an identification of the individual purchaser based upon an identification scheme used by the provider from which the information is retrieved. Purchaser identification used by the provider is able to include, for example, a frequent shopper identification number, a checking account number, a credit card number or any other identification that serves to identify the purchaser with the purchase data contained in the purchase history.

Once the purchase history data is retrieved from the various providers, the processing proceeds by associating, at step 604, the retrieved purchase history data with the proper user account on the targeted information and incentive distribution system. The exemplary embodiment of the present invention allows users to specify providers, such as retailers, service providers, credit card companies, and so forth, from which purchase history data is to be retrieved for that user's targeted information and incentive distribution account. The user of the exemplary embodiment further provides a specification of the purchaser identification that is used by each provider, such as the frequent shopper number or other identification, to allow the program administration server 102 to correlate the received personal identification with the individual's user account.

The processing continues by storing, at step 606, the retrieved purchase history information into the temporary database 220 in association with the user's account for the targeted information and incentive system. The temporary database 220 of the exemplary embodiment temporarily stores purchase history data for all of the users of the targeted information and incentive system prior to the user's logging onto the program administration server 102. The temporary database of the exemplary embodiment stores data for sixty days before the data is permanently deleted from the temporary database. Retaining data in the temporary database for such a relatively short period of time and then permanently deleting that data serves to enhance the security of the user's personal data. Users may have the option to reduce their security if they want their data held in the temporary database for longer time periods.

The processing then waits for a particular user to log into the program administration server 102, which hosts the temporary database processing in the exemplary embodiment. The processing accepts, at step 608, a login from a user who is operating his or her own computer. The exemplary embodiment of the present invention supports user logins through a variety of techniques. The exemplary embodiment utilizes secure data communications to allow a user to use a dedicated program that is loaded into and run on the user's computer that is typically in a user's home or workplace. User login process establishes a secure communications link that supports secure data transfer through a conventional File Transfer Protocol (FTP) connection that uses a Secure Socket Layer (SSL) interface to ensure the privacy of the communicated data. Other embodiments use other suitable communications links. User authentication during the login processing in the exemplary embodiment is able to use encrypted passwords, biometric measurements, and/or other user authentication techniques known to ordinary practitioners in the relevant arts.

Once a user is logged in and a secure communications link is established between the user's computer and the program administration server 102 of the exemplary embodiment, the processing then downloads, at step 610, the purchase history information for only that user to the user's computer from the temporary database 220. Security mechanisms within the program administration server 102 of the exemplary embodiment ensure that a user only receives information about his or her own purchases and that the information of other users is not made available to the logged in user.

After a user downloads his or her purchase history information from the temporary database 220, the processing of the exemplary embodiment purges, at step 612, from the temporary database the data that has been downloaded to the user computer. This advantageously enhances the security of the user's data in the exemplary embodiment of the present invention by ensuring that an accumulation of the user's purchase history data is not maintained anywhere except in the user's own computer. Other embodiments are able to retain the data for a specified period of time, even after the user downloads the data.

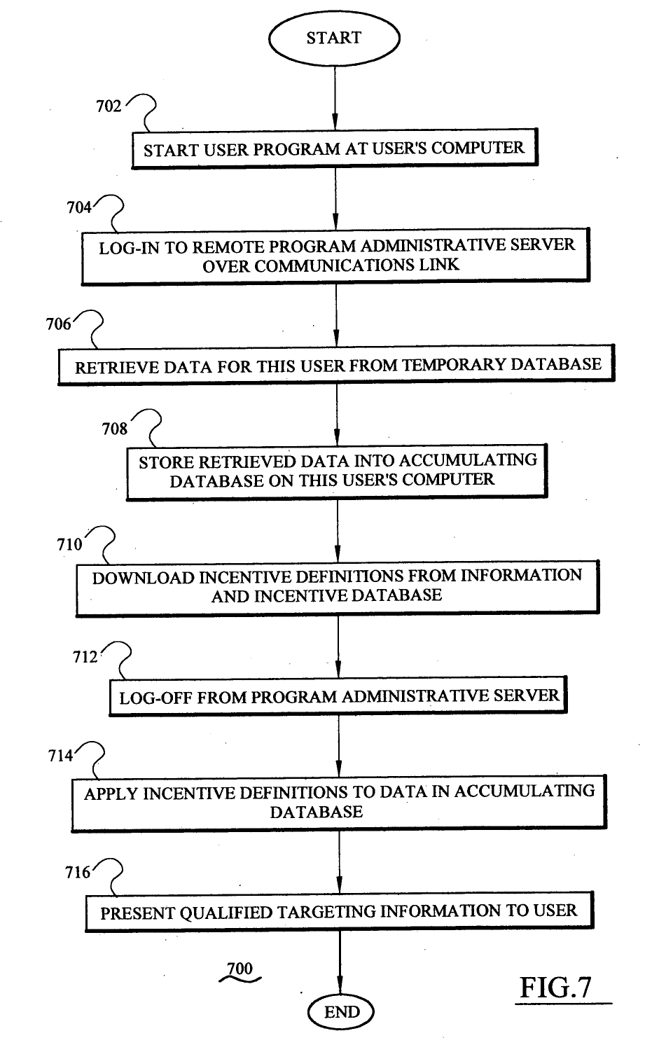

An individual user incentive program processing 700 flow diagram as used within an exemplary targeted information and incentive distribution system in accordance with an exemplary embodiment of the present invention is illustrated in FIG. 7. The individual user incentive program processing 700 is performed on a user computer in the exemplary embodiment of the present invention. This user computer is typically located in the user's home or workplace and is under the physical control of the user. Some embodiments of the present invention perform the individual user incentive program processing 700 on computers that are remote from the individual users, some of which perform this processing for multiple users. These embodiments incorporate security features to ensure that data for each user is protected and that individual users are able to only access his or her own data.

The individual user incentive program processing 700 begins by starting, at step 702, the individual user program at the user's computer. Examples of individual user computers in the exemplary embodiment are User A computer 114 and User B computer 112. Once the program has started, the processing advances by allowing the user to log in, at step 704, to the program administration server 102 over the communications link 110. As discussed above, the log in processing is able to use a variety of communications and authentication methods to establish a secure communications link between the user computer and the program administration server 102 in the exemplary embodiment.

Once the user has logged into his or her account on the program administration server 102, the processing advances to retrieving data for this user from the temporary database 220. The processing then stores, at step 708, this retrieved data into the accumulating purchase history database that is maintained on the user computer. Examples of accumulating purchase history databases are the User A accumulating purchase history database 214 and the User B accumulating purchase history database 212. The accumulating purchase history database of the exemplary embodiment accumulates purchase history data over time to support determination of targeted information and incentives to be provided to this user.

The processing of the exemplary embodiment also downloads, at step 710, incentive definitions from the information and incentives database 222 of the exemplary embodiment. The order of downloading purchase history data and information/incentive information is immaterial and is able to be performed in any order or concurrently. Downloaded incentive and information definitions are stored in a user information and incentive database, such as the User A information and incentive database 224 or the User B information and incentive database 226. Information and incentive definitions are communicated either as an entire database or as an update to a database that is stored on the user computer. Embodiments of the present invention utilize various known techniques of updating remote databases.

The processing then logs the user off, at step 712, from the program administration server 102. This logoff processing closes the secure communications link from the user computer to the program administration server 102. The processing then applies, at step 714, the information and incentive descriptions, that are stored in the user information and incentive definitions, to the updated purchase history data stored in the updated user accumulating purchase history database 508. Application of the information and incentive descriptions to the user's purchase history includes comparing the conditions of the targeted information and incentives in the information and incentive definitions to the purchase history data to determine information and incentives to which that user is entitled. As discussed herein, the exemplary embodiment of the present invention allows a user to modify his or her purchase history database. The information and incentive definitions allow controlling whether the determination of incentives to provide to individual users includes or excludes changes the user has made to his or her purchase history database.

In addition to comparing the conditions of the targeted information within information and incentive definitions to the user's purchase history data, the conditions of the targeted information are further able to include specified characteristics of the user that are required for delivery of the information or incentive to the user. Such specified-characteristics include, for example, satisfaction of a particular cluster definition, satisfaction of specified demographic and/or life-style characteristics, or specified responses to previously or concurrently completed survey questions. User characteristics are able to be determined within the user computer by, for example, patterns of personal data provided by the user but that is retained within the computer, such as family status, household size, and so forth.

The processing then advances by presenting, at step 716, the targeted information and incentives for which the user qualifies based upon the information and incentive definitions. Targeted information is presented to the user in a variety of ways, including through a World Wide Web browser, printing the information and/or incentives on a printer, and/or presentation using another viewing apparatus. A summary list of available information and incentives is also able to be presented to the user for selection of desired incentives and information to view and/or use.

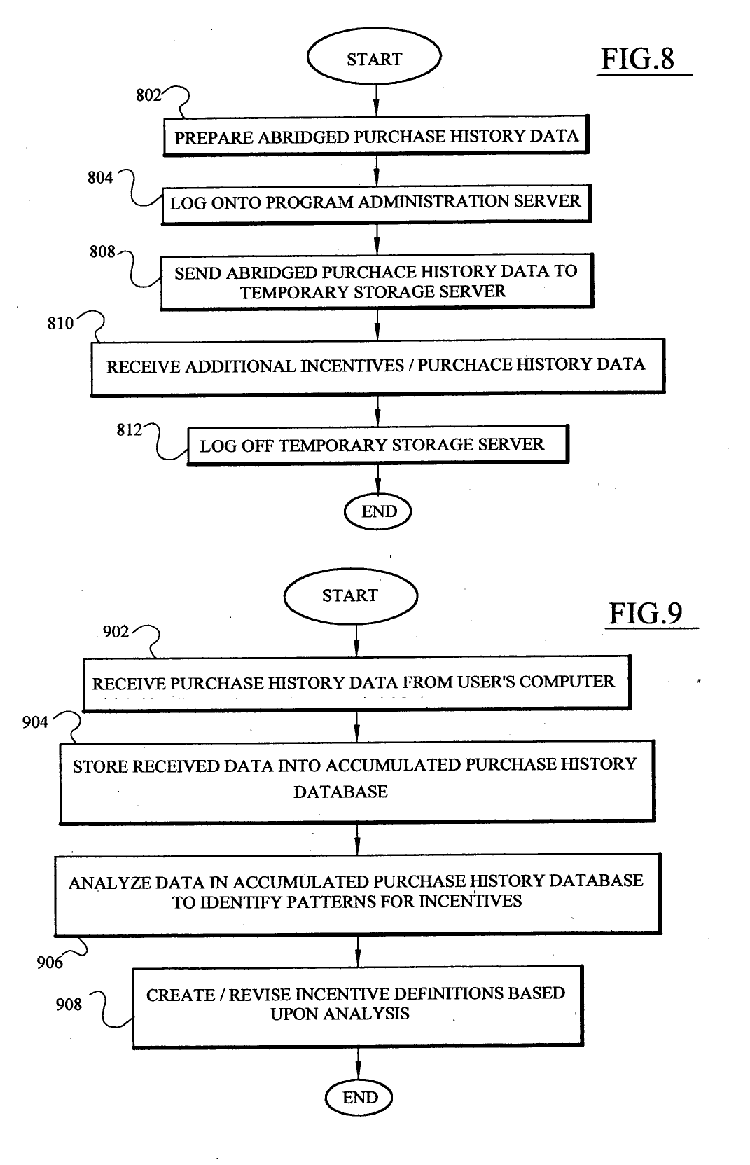

An upload abridged data processing 800 flow diagram as used within an exemplary targeted information and incentive distribution system in accordance with an exemplary embodiment of the present invention is illustrated in FIG. 8. In addition to the distribution and provision of targeted information and incentives to users, the exemplary embodiment of the present invention further accumulates abridged purchase history data from all individuals who use the system. This accumulated purchase history data is used to analyze the effectiveness of previously provided targeted incentives and to develop future incentive targeting strategies. The abridged purchase history data in the exemplary embodiment is accumulated in the program administration server 102 and includes purchase data along with an anonymous identification of the user making the purchase. The exemplary embodiment of the present invention uses a random but unique serial number that is assigned to the individual user but that the targeted information and incentive distribution system does not in any way correlate to the identity of the user. The serial number used with the abridged purchase history data in the exemplary embodiment is initially assigned to the software copy that is delivered to the individual user for installation into his or her user computer or that is delivered when the user registers with the targeted information and incentive distribution system. This number may periodically and randomly be changed in order to provide additional security and protection to user identity. The operation of the exemplary embodiment does not use this serial number for any other purpose and does not correlate this number to other user identifying information. This allows purchase history data from multiple households to be anonymously accumulated without compromising the privacy of the individuals using the system. The accumulated abridged purchase history data provides an ability to analyze accumulated purchase history data that represents purchases made by individual households that are made at the different retail outlets or service providers at which the individual households shop.

The abridged purchase history data processing 800 is performed by the user computer in the exemplary embodiment and begins by preparing, at step 802, abridged data to be communicated to the program administration server 102. Preparation of abridged purchase data includes removing any information that identifies the individual user. The abridged purchase history data of the exemplary embodiment includes only a list of UPCs for purchased items, the purchase date and the user serial number. The purchase price of items is also able to be included in the abridged purchase history data. Further embodiments of the present invention include other data within the abridged purchase history data, such as retailer where purchased, user survey responses, demographic and life-style data, zip code, and so forth. The abridged purchase history data of the exemplary embodiment does not, however, include an individual's name, address, social security or tax identification number, or any information that is known to provide identify of any user.

The processing then logs in the user, at step 804, to the program administration server 102. This log in procedure includes establishing a secure data communications link as was performed for downloading purchase history data from the temporary purchase history database 220. The user log in procedure for transferring abridged purchase history data uses a different log in identifier that is used to identify the user for downloading purchase history data from the temporary purchase history database. This serves to further safeguard individual user's privacy in their purchase transaction and other personal data. The processing then sends, at step 808, the abridged purchase history data to the program administration server, which stores it into the abridged purchase history database 414.

A process abridged data processing 900 flow diagram as used within an exemplary targeted information and incentive distribution system in accordance with an exemplary embodiment of the present invention is illustrated in FIG. 9. The process abridged data processing 900 is performed by the abridged purchase history analyzer 410 in the exemplary embodiment. The process abridged data processing begins by receiving, at step 902, abridged purchase history data from user computers 500. The abridged purchase history data received from users' computers in the exemplary embodiment includes, for example, lists of items purchased, the entity selling the item, any incentives used in the purchase and the time/date of the purchase. The received data is then stored, at step 904, by being added into an abridged purchase history database 414. Information that can be derived from the abridged purchase history database 414 includes National, Regional, and Retailer specific purchases by size, Brand, and category in pre, during, and post promotional message delivery periods, according to user defined date ranges, Purchases of all Consumers combined, Purchases according to cluster identifier (demographic, purchase history, promotion response, life-style, etc.), Purchases according to actual price paid, and Purchases among coupon (other promotion) redeemers and non-coupon redeemers. This data further includes National, Regional, and Retailer specific Market Share in pre, during, and post promotional message delivery periods, according to user defined date ranges, including: Unit and statistical unit share, Dollar share based on actual price paid by Consumer, reflecting coupons used, and Share among coupon (other promotion) redeemers and non-coupon redeemers.

The data within the abridged purchase history database 414 is then analyzed, at step 906, to identify purchasing patterns to assist in defining future targeted incentives to be provided to individuals based upon purchase histories. The data within the abridged purchase history database 414 is also analyzed to evaluate the effectiveness of previously offered incentives. The analysis of abridged purchase history data in the exemplary embodiment further includes analytical and other processing steps that are performed by humans. Data that can be derived from this analysis includes: loyalty, promotion sensitivity, promotion/message effectiveness, demographic and geographic skews, retailer skews, price sensitivity (prices are the actual paid by the consumer, including discounts and, possibly, coupons), new item potential—who buys and why, and profit by cluster, when cost data is available.

After analysis of the abridged purchase history data, the processing allows creation and/or revision, at step 908, of incentive definitions stored in the information and incentive database 222 of the exemplary embodiment. These new or revised incentives are then distributed to user computer as described herein.

Promoters that are registered with the program administration server 102, or those promoters' agents, are able to also have direct access to abridged purchase history database 414. This access allows the promoter to conduct research that will allow a promoter to better target promotions to users who find those promotions more relevant. Promoters further have an ability to define and to specify particular clusters characteristics for their own purposes. A Promoter in the exemplary embodiment must be registered in order to have this access to this abridged user data or to provide such targeted promotions and/or information to users. If users complain, or if inappropriate messages are sent to the users, the Promoter registration is able to be revoked and/or the Promoter may be fined. Promoters in the exemplary embodiment pay a fee to register and pay further fees for usage. This process provides additional protection to the users and greatly simplifies administration relative to other targeted promotion systems currently available. Further embodiments of the present invention do not retain a copy of the user information and incentive database 506 on the user computer 500. Some embodiments of the present invention transmit cluster definition data to the user computer 500. The processing of the user computer then determines cluster identifier based upon the cluster definitions, received purchase history and other personal information. These determined cluster identifiers are then transmitted to the program administration server 102 and matched to cluster identifiers associated with incentives and information stored in the information and incentive database 222. These embodiments operate to download only those incentives and information relevant with matching cluster identifiers to the qualified incentive database 504 of the user computer 500.

The exemplary embodiment of the present invention provides several benefits to individual users. These benefits include convenient creation of customized shopping lists that save time by allowing shopping lists to be created from past purchase patterns. These shopping lists also support ease of adding items to list from pre-defined meal plans, and special offers. Shopping lists can further be organized by department/category to simplify the shopping trip. The shopping lists created by this embodiment can be accessed on Cell Phones and PDAs while away from home. The shopping list can also be used with home shopping services. Further advantages include cash savings opportunities targeted to the individual's needs. Created shopping lists can include instant credits that are flagged on the created shopping list, linked to a frequent shopper card program, and deducted at POS. Other advantages include coupons that can be printed and taken to the store and that are limited per household by adding the coupon UPC to the transaction and then added to consumer database. Yet other advantages include home credit accumulation for delayed benefits, including purchases verified in Consumer software. Additional advantages and features include issuance of primary Retailer certificates (e.g., $20 or more) where a promoter pays the incentive system operator as credits accumulate through funds held in escrow. The system use certificates that identify specific promotions that were paid. Further advantages and features include issuance of points use for online purchases, mail-in offers that can be printed and limited per household, notification of coupons that are available in newspaper, magazines, etc. Such other coupons can be flagged on a shopping list. Yet other advantages and features include convenient help in planning meals and access to useful information. The exemplary embodiment further advantageously allows communications between promoters, suppliers, retailers and customers without risk of spam or pop-ups and convenient access to useful information.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when loaded and executed, controls the computer system such that it carries out the methods described herein.

The present invention can also be embedded in a computer program product, which comprises all the features enabling the implementation of the methods described herein, and which—when loaded in a computer system—is able to carry out these methods. In the present context, a “computer program” includes any expression, in any language, code or notation, of a set of instructions intended to cause a system having an information processing capability to perform a particular function either directly or after either or both of the following: a) conversion to another language, code, or notation; and b) reproduction in a different material form.

Each computer system may include one or more computers and a computer readable medium that allows the computer to read data, instructions, messages, or message packets, and other computer readable information from the computer readable medium. The computer readable medium may include non-volatile memory such as ROM, Flash memory, a hard or floppy disk, a CD-ROM, or other permanent storage. Additionally, a computer readable medium may include volatile storage such as RAM, buffers, cache memory, and network circuits. Furthermore, the computer readable medium may include computer readable information in a transitory state medium such as a network link and/or a network interface (including a wired network or a wireless network) that allow a computer to read such computer readable information.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

1. A method for delivering targeted incentives, the method comprising the steps of:
receiving a set of purchase history data at a processor under the control of a user;
receiving at least one specification of targeted information at the processor, wherein the at least one specification comprises at least a condition and a targeted information item; and
determining, at the processor and based upon the condition within the at least one specification and based upon the set of purchase history data, at least one targeted information item to present to the user.

2. The method according to claim 1, further comprising the steps of:
receiving, at the processor, at least one consumer cluster definition; and
determining, at the processor, if the user is to be assigned to a specific cluster within the at least one consumer cluster definition, and
wherein the condition within the at least one specification of targeted information specifies a cluster.

3. The method according to claim 1, wherein at least one condition within the at least one specification of targeted information comprises at least one of a condition that the user has purchased at least one specified item and a condition that the user has made a transaction within a value range.

4. The method according to claim 1, wherein at least one targeted information item within the at least one specification of targeted information comprises a purchasing incentive.

5. The method according to claim 1, wherein at least one targeted information item within the at least one specification of targeted information comprises a recall notice.

6. The method according to claim 1, wherein at least one targeted information item within the at least one specification of targeted information comprises nutritional information for an item specified in the condition of the at least one specification.

7. The method according to claim 1, wherein at least one targeted information item within the at least one specification of targeted information comprises a message to provide to the user.

8. The method according to claim 1, wherein at least one targeted information item within the at least one specification of targeted information comprises at least one of a purchase recommendation and a service recommendation, based upon an item specified in the condition of the at least one specification.

9. The method according to claim 1, wherein at least one targeted information item within the at least one specification of targeted information comprises at least one of an in-store discount and a travel discount.

10. The method according to claim 1, wherein at least one targeted information item within the at least one specification of targeted information comprises information concerning combination of items specified in the condition of the at least one specification

11. The method according to claim 1, wherein the processor comprises a computer that is one of owned by the user and under control of the user.

12. The method according to claim 1, further comprising the step of receiving data to be presented to the user over a secure communications link.

13. The method according to claim 1, further comprising the step of determining data defining at least one characteristic of the user, and wherein the at least one condition comprises at least one specified characteristic of the user.

14. The method according to claim 13, wherein the condition is determined based upon preferences determined by analyzing other users with characteristics similar to the at least one specified characteristic.

15. The method according to claim 1, wherein the purchase history data is derived from a plurality of providing entities, and wherein at least two of the providing entities within the plurality of providing entities are operated by separate companies.

16. The method according to claim 1, further comprising the step of:
generating a shopping list, the shopping list depending at least in part on the purchase history data.

17. The method according to claim 16, further comprising the steps of:
accepting, from a user, a modification for the shopping list; and
altering the shopping list in response to the modification.

18. The method according to claim 1, further comprising the step of presenting the user with a set of nutritional information based at least in part on the purchase history data.

19. The method according to claim 18, further comprising the step of storing a description of a household composition associated with the user, and wherein the nutritional information includes a description of nutritional information for each individual described in the household composition.

20. The method according to claim 19, wherein the household composition comprises a description of items consumed by at least one individual described within the household composition.

21. The method according to claim 1, wherein at least one targeted information item within the at least one specification of targeted information comprises a notification for a coupon available from a conventional source.

22. The method according to claim 21, wherein the conventional source is one of a publication and an in-store coupon source.

23. The method according to claim 1, further comprising the step of presenting the user with at least one recipe, wherein the at least one recipe is selected based upon the purchase history data.

24. The method according to claim 23, further comprising the step of estimating the user's consumption of items within the purchase history data in order to determine an estimation of items on hand, and wherein the at least one recipe is selected based upon the estimation of items on hand.

25. A method for notifying a user of an incentive, the method comprising the steps of:
analyzing at least one entry of a purchase history of a user;
determining, based upon the analyzing, a preference of the user;
identifying a printed incentive that is located in one of a publication and a location, wherein the incentive is identified based upon the preference; and
notifying the user of the incentive and the one of the publication and the location.

26. The method according to claim 25, wherein location is a retailer and the notification identifies the retailer.

27. A method for analyzing purchase history data, the method comprising:
receiving, from a plurality of processors, abridged purchase history data, wherein each of the plurality of processors is under the control of an individual user and wherein the abridged purchase history data from each of the plurality of processors is associated with the individual user controlling that processor, and wherein the abridged purchase history data has been processed on at least some of the plurality of processors to remove personal identification data;
storing the abridged purchase history data in a database; and
analyzing a data set from the database.

28. The method according to claim 27, further comprising:
accepting personal data at a processor within the plurality of processors, wherein the processor is under the control of the individual user and the personal data relates to the individual user;
removing the personal identification data from the personal data to create an abridged personal history data set; and
transmitting the abridged personal history data set to a remote analysis system.

29. A method for providing targeted information, the method comprising the steps of:
retrieving purchase history information from more than one provider;
associating each data item within the purchase history information with one of a plurality of users; and
transmitting to a selected user in the plurality of users at least a portion of the purchase history information, wherein all of the at least a portion of the purchase history information is associated with the selected user.

30. A method for providing targeted information to a user, the method comprising the steps of:
retrieving purchase history information from more than one provider;
associating each data item within the purchase history information with one of a plurality of users;
transmitting to a selected user in the plurality of users at least a portion of the purchase history information, wherein the at least a portion of the purchase history information is associated with the selected user;
receiving the at least a portion of the purchase history information at a processor under the control of the user;
receiving at least one specification of targeted information at the processor, wherein the at least one specification comprises at least a condition and a targeted information item; and
determining, at the processor and based upon the condition within the at least one specification and based upon the at least a portion of the purchase history information, at least one targeted information item to present to the user.

31. A targeted information and/or incentive delivery system, comprising:
a data retrieval processor for receiving a set of purchase history data at the processor, wherein the processor is under the control of a user;
an incentive receiving processor for receiving at least one specification of targeted information at the processor, wherein the at least one specification comprises at least a condition and a targeted information item; and
an incentive determination processor for determining, at the processor and based upon the condition within the at least one specification and based upon the set of purchase history data, at least one targeted information item to present to the user.

32. The targeted information and/or incentive delivery system according to claim 31, further comprising:
a cluster definition receiver for receiving, at the processor, at least one consumer cluster definition; and
a cluster determination processor for determining, at the processor, if the user is to be assigned to a specific cluster within the at least one consumer cluster definition, and
wherein the condition within the at least one specification of targeted information specifies a cluster.

33. The targeted information and/or incentive delivery system according to claim 31, wherein at least one condition within the at least one specification of targeted information comprises at least one of a condition that the user has purchased a specified item and a condition that the user has made a transaction within a value range.

34. The targeted information and/or incentive delivery system according to claim 31, wherein at least one targeted information item within the at least one specification of targeted information comprises a purchasing incentive.

35. The targeted information and/or incentive delivery system according to claim 31, wherein at least one targeted information item within the at least one specification of targeted information comprises a recall notice.

36. The targeted information and/or incentive delivery system according to claim 31, wherein at least one targeted information item within the at least one specification of targeted information comprises nutritional information for an item specified in a condition of the at least one specification.

37. The targeted information and/or incentive delivery system according to claim 31, wherein at least one targeted information item within the at least one specification of targeted information comprises a message to provide to the user.

38. The targeted information and/or incentive delivery system according to claim 31, wherein at least one targeted information item within the at least one specification of targeted information comprises at least one of a purchase recommendation and a service recommendation, based upon an item specified in a condition of the at least one specification.

39. The targeted information and/or incentive delivery system according to claim 31, wherein at least one targeted information item within the at least one specification of targeted information comprises at least one of an in-store discount and a travel discount.

40. The targeted information and/or incentive delivery system according to claim 31, wherein at least one targeted information item within the at least one specification of targeted information comprises information concerning combination of items specified in a condition of the at least one specification.

41. The targeted information and/or incentive delivery system according to claim 31, wherein the processor comprises a computer owned by the user.

42. The targeted information and/or incentive delivery system according to claim 31, wherein data received by the processor is received over a secure communications link.

43. The targeted information and/or incentive delivery system according to claim 31, further comprising:
a user database for storing data defining at least one characteristic of the user, and wherein the at least one condition comprises at least one specified characteristic of the user.

44. The targeted information and/or incentive delivery system according to claim 43, wherein the condition is determined based upon preferences determined by analyzing other users with characteristics similar to the at least one specified characteristic.

45. The targeted information and/or incentive delivery system according to claim 31, wherein the purchase history data is derived from a plurality of providing entities, and wherein at least two of the providing entities within the plurality of providing entities are operated by separate companies.

46. The targeted information and/or incentive delivery system according to claim 31, further comprising:
a shopping list generator for generating a shopping list, the shopping list depending at least in part on the purchase history data.

47. The targeted information and/or incentive delivery system according to claim 46, further comprising:
a user interface for accepting, from a user, a modification for the shopping list; and
wherein the shopping list generator alters the shopping list in response to the modification.

48. The targeted information and/or incentive delivery system according to claim 31, further comprising a personal data presentation processor for presenting the user with a set of nutritional information based at least in part on the purchase history data.

49. The targeted information and/or incentive delivery system according to claim 48, further comprising a user database for storing a description of a household composition associated with the user, and wherein the nutritional information includes a description of nutritional information for each individual described in the household composition.

50. The targeted information and/or incentive delivery system according to claim 48, wherein the household composition comprises a description of items consumed by at least one individual described within the household composition.

51. The targeted information and/or incentive delivery system according to claim 31, wherein at least one targeted information item within the at least one specification of targeted information comprises a notification for a coupon available from a conventional source.

52. The targeted information and/or incentive delivery system according to claim 51, wherein the conventional source is one of a publication and an in-store coupon source.

53. The targeted information and/or incentive delivery system according to claim 31, further comprising a personal data presentation processor for presenting the user with at least one recipe, wherein the at least one recipe is selected based upon the purchase history data.

54. The targeted information and/or incentive delivery system according to claim 53, further comprising a usage pattern detector for estimating the user's consumption of items within the purchase history data in order to determine an estimation of items on hand, and wherein the at least one recipe is selected based upon the estimation of items on hand.

55. A targeted incentive notifier, the targeted incentive notifier comprising:
a usage pattern detector for:
analyzing at least one entry of a purchase history of a user; and
determining, based upon the analyzing, a preference of the user;
a incentive determination processor for identifying a printed incentive that is located in one of a publication and a location, wherein the incentive is identified based upon the preference; and
a personal data presentation processor notifying the user of the incentive and the one of the publication and the location.

56. The targeted incentive notifier according to claim 55, wherein location is a retailer and the notification identifies the retailer.

57. A data analyzer, comprising:
a data receiver for receiving, from a plurality of processors, abridged purchase history data, wherein each of the plurality of processors is under the control of an individual user and wherein the abridged purchase history data from each of the plurality of processors is associated with the individual user controlling that processor, and wherein the abridged purchase history data has been processed on at least some of the plurality of processors to remove personal identification data;
a database manager for storing the abridged purchase history data in a database; and
a purchase history analyzer for analyzing a data set from the database.

58. The data analyzer according to claim 57, further comprising:
a user computer for accepting personal data, wherein the user computer is under the control of the individual user and the personal data relates to the individual user;
a data reducer for removing personal identification data from the personal data to create an abridged personal history data set; and
a data transmitter transmitting the abridged personal history data set to a remote analysis system.

59. A targeted information and/or incentive delivery system for providing targeted information and/or incentives, the targeted information and/or incentive delivery system comprising:
a purchase history data receiver for retrieving purchase history information from more than one provider; and
a purchase data access processor for:
associating each data item within the purchase history information with one of a plurality of users; and
transmitting to a selected user in the plurality of users at least a portion of the purchase history information, wherein all of the at least a portion of the purchase history information is associated with the selected user.

60. A targeted information and/or incentive delivery system for providing targeted information and/or incentives to a user, the targeted information and/or incentive delivery system comprising:
a purchase history data receiver for retrieving purchase history information from more than one provider;
a purchase data access processor for:
associating each data item within the purchase history information with one of a plurality of users;
transmitting to a selected user in the plurality of users at least a portion of the purchase history information, wherein all of the at least a portion of the purchase history information is associated with the selected user;
a data retrieval processor for receiving the at least a portion of the purchase history information at a processor under the control of the user;
an incentive receiving processor for receiving at least one specification of targeted information at the processor, wherein the at least one specification comprises at least a condition and a targeted information item; and
an incentive determination processor for determining, at the processor and based upon the condition within the at least one specification and based upon the set of purchase history data, at least one targeted information item to present to the user.

61. A machine-readable medium encoded with a program for delivering targeted incentives, the program containing instructions for:
receiving a set of purchase history data at a processor under the control of a user;
receiving at least one specification of targeted information at the processor, wherein the at least one specification comprises at least a condition and a targeted information item; and
determining, at the processor and based upon the condition within the at least one specification and based upon the set of purchase history data, at least one targeted information item to present to the user.

62. The machine-readable medium according to claim 61 further comprising instructions for:
receiving, at the processor, at least one consumer cluster definition; and
determining, at the processor, if the user is to be assigned to a specific cluster within the at least one consumer cluster definition, and
wherein the condition within the at least one specification of targeted information specifies a cluster.

63. The machine-readable medium according to claim 61, wherein at least one condition within the at least one specification of targeted information comprises at least one of a condition that the user has purchased at least one specified item and a condition that the user has made a transaction within a value range.

64. The machine-readable medium according to claim 61, wherein at least one targeted information item within the at least one specification of targeted information comprises a purchasing incentive.

65. The machine-readable medium according to claim 61, wherein at least one targeted information item within the at least one specification of targeted information comprises a recall notice.

66. The machine-readable medium according to claim 61, wherein at least one targeted information item within the at least one specification of targeted information comprises nutritional information for an item specified in a condition of the at least one specification.

67. The machine-readable medium according to claim 61, wherein at least one targeted information item within the at least one specification of targeted information comprises a message to provide to the user.

68. The machine-readable medium according to claim 61, wherein at least one targeted information item within the at least one specification of targeted information comprises at least one of a purchase recommendation and a service recommendation, based upon an item specified in a condition of the at least one specification

69. The machine-readable medium according to claim 61, wherein at least one targeted information item within the at least one specification of targeted information comprises at least one of an in-store discount and a travel discount.

70. The machine-readable medium according to claim 61, wherein at least one targeted information item within the at least one specification of targeted information comprises information concerning combination of items specified in a condition of the at least one specification.

71. The machine-readable medium according to claim 61, wherein the processor comprises a computer owned by the user.

72. The machine-readable medium according to claim 61, further comprising instructions for receiving data to be presented to the user over a secure communications link.

73. The machine-readable medium according to claim 61, further comprising instructions for:
determining data defining at least one characteristic of the user, and wherein the at least one condition comprises at least one specified characteristic of the user.

74. The method according to claim 73, wherein the condition is determined based upon preferences determined by analyzing other users with characteristics similar to the at least one specified characteristic.

75. The machine-readable medium according to claim 61, wherein the purchase history data is derived from a plurality of providing entities, and wherein at least two of the providing entities within the plurality of providing entities are operated by separate companies.

76. The machine-readable medium according to claim 61, further comprising instructions for:
generating a shopping list, the shopping list depending at least in part on the purchase history data.

77. The machine-readable medium according to claim 76, further comprising instructions for:
accepting, from a user, a modification for the shopping list; and
altering the shopping list in response to the modification.

78. The machine-readable medium according to claim 61, further comprising instructions for presenting the user with a set of nutritional information based at least in part on the purchase history data.

79. The machine-readable medium according to claim 78, further comprising instructions for storing a description of a household composition associated with the user, and wherein the nutritional information includes a description of nutritional information for each individual described in the household composition.

80. The machine-readable medium according to claim 79, wherein the household composition comprises a description of items consumed by at least one individual described within the household composition.

81. The machine-readable medium according to claim 61, wherein at least one targeted information item within the at least one specification of targeted information comprises a notification for a coupon available from a conventional source.

82. The machine-readable medium according to claim 81, wherein the conventional source is one of a publication and an in-store coupon source.

83. The machine-readable medium according to claim 61, further comprising instructions for presenting the user with at least one recipe, wherein the at least one recipe is selected based upon the purchase history data.

84. The machine-readable medium according to claim 83, further comprising instructions for estimating the user's consumption of items within the purchase history data in order to determine an estimation of items on hand, and wherein the at least one recipe is selected based upon the estimation of items on hand.

85. A machine-readable medium encoded with a program for notifying a user of an incentive, the program containing instructions for:
analyzing at least one entry of a purchase history of a user;
determining, based upon the analyzing, a preference of the user;
identifying a printed incentive that is located in one of a publication and a location, wherein the incentive is identified based upon the preference; and
notifying the user of the incentive and the one of the publication and the location.

86. The machine-readable medium according to claim 85, wherein the location is a retailer and the notification identifies the retailer.

87. A machine-readable medium encoded with a program for analyzing purchase history data, the program containing instructions for:
receiving, from a plurality of processors, abridged purchase history data, wherein each of the plurality of processors is under the control of an individual user and wherein the abridged purchase history data from each of the plurality of processors is associated with the individual user controlling that processor, and wherein the abridged purchase history data has been processed on at least some of the plurality of processors to remove personal identification data;
storing the abridged purchase history data in a database; and
analyzing a data set from the database.

88. A machine-readable medium encoded with a program for providing targeted information, the program containing instructions for:
retrieving purchase history information from more than one provider;
associating each data item within the purchase history information with one of a plurality of users; and
transmitting to a selected user in the plurality of users at least a portion of the purchase history information, wherein all of the at least a portion of the purchase history information is associated with the selected user.

89. A machine-readable medium encoded with a program for providing targeted information to a user, the program containing instructions for:
retrieving purchase history information from more than one provider;
associating each data item within the purchase history information with one of a plurality of users;
transmitting to a selected user in the plurality of users at least a portion of the purchase history information, wherein all of the at least a portion of the purchase history information is associated with the selected user;
receiving the at least a portion of the purchase history information at a processor under the control of the user;
receiving at least one specification of targeted information at the processor, wherein the at least one specification comprises at least a condition and a targeted information item; and
determining, at the processor and based upon the condition within the at least one specification and based upon the set of purchase history data, at least one targeted information item to present to the user.
